(19) United States
(12) Patent Application Publication
(10) Pub. No.: US 2024/0262181 A1
(43) Pub. Date: Aug. 8, 2024

(54) ACTIVE COOLING SYSTEMS FOR A BICYCLE

(71) Applicant: Trek Bicycle Corporation, Waterloo, WI (US)

(72) Inventors: Madeline Spurlock, Madison, WI (US); Mitchell Plout, Madison, WI (US); Benjamin Blaise Fullerton, Jr., Madison, WI (US)

(21) Appl. No.: 18/435,474

(22) Filed: Feb. 7, 2024

Related U.S. Application Data
(60) Provisional application No. 63/483,554, filed on Feb. 7, 2023.

(51) Int. Cl. B60K 11/06; B62J 43/28; B62J 45/20; B62J 45/41; B62M 6/40; H01M 10/613; H01M 10/625; H01M 10/6563

(52) U.S. Cl. CPC B60K 11/06; B62J 43/28; B62J 45/20; B62J 45/41; B62M 6/40; H01M 10/613; H01M 10/625; H01M 10/6563; H01M 2250/20

(57) ABSTRACT

An electric bicycle includes a frame that includes a top tube, a down tube, and a seat tube. The electric bicycle also includes an electric motor mounted on or within at least one of the down tube and the seat tube. The electric bicycle further includes a cooling system mounted proximate to the electric motor, wherein the cooling system maintains a desired operating temperature for the electric motor.

### CROSS-REFERENCE TO RELATED APPLICATION

The present application claims the priority benefit of U.S. Provisional Patent App. No. 63/483,554 filed on Feb. 7, 2023, the entire disclosure of which is incorporated by reference herein.

### BACKGROUND

An electric bicycle (or e-bike) refers to a bicycle that is equipped with an electric motor. In modern e-bikes, the electric motor is often mounted within one of the tubes that form the frame of the bicycle. The electric motor is typically powered by a rechargeable battery that can be recharged via power received through an electrical outlet or as a result of a user operating the pedals of the bicycle. In operation, the electric motor acts to assist the user with pedaling of the bicycle. In many e-bikes, the amount of assistance provided by the electric motor can be controlled by the user.

### SUMMARY

An illustrative electric bicycle includes a frame that includes a top tube, a down tube, and a seat tube. The electric bicycle also includes an electric motor mounted on or within at least one of the down tube and the seat tube. The electric bicycle further includes a cooling system mounted proximate to the electric motor, wherein the cooling system maintains a desired operating temperature for the electric motor.

In one embodiment, the cooling system includes a fan that is configured to blow air over at least a portion of the electric motor to maintain the desired operating temperature. In another embodiment, the system includes a battery cover that covers a battery of the electric bicycle, where the battery cover includes a plurality of air intake vents that act as an intake for the fan. In an illustrative embodiment, the air intake vents are ribbed to keep out dust and debris. The system can also include a motor cover that covers the electric motor, where the motor cover includes a first plurality of exhaust vents that act as an exhaust for the fan. In another embodiment, the first plurality of exhaust vents are positioned at a top of the motor cover, and a second plurality of exhaust vents are positioned at a bottom of the motor cover. The system can also include a fan mount that mounts to the frame, where the fan mount includes an opening to receive the fan. In one embodiment, at least a portion of a perimeter of the fan mount includes gasket edges that form a seal with the frame. The seal prevents air leaks such that airflow from the fan is forced over the electric motor. In another embodiment, the fan enters a pulse mode in response to detection of a fan blockage, and the fan intermittently pulses during the pulse mode until the fan blockage is no longer present.

In one embodiment, the cooling system includes a pump that distributes a coolant over at least a portion of the electric motor to maintain the desired operating temperature. In such an embodiment, the cooling system includes a motor cover that mounts to the electric motor and delivers the coolant to the electric motor. In another embodiment, an interior side of the motor cover that faces the electric motor includes a coolant path that circulates the coolant over the electric motor. The coolant path is etched into the interior side of the motor cover. In another embodiment, the motor cover includes a coolant input and a coolant output that enables circulation of the coolant along the motor cover. The coolant input and the coolant output are each connected to a coolant tube that connects to the pump.

In another embodiment, the system includes a temperature sensor mounted on or proximate to the electric motor, where the temperature sensor detects an operating temperature of the electric motor. The system can also include a computing system to receive the operating temperature of the electric motor from the temperature sensor. In one embodiment, the computing system is mounted in the top tube of the frame. In another embodiment, the computing system compares the operating temperature of the electric motor to a threshold temperature, and the computing system activates the cooling system responsive to a determination that the operating temperature exceeds the threshold temperature. In another embodiment, the computing system receives an updated operating temperature of the electric motor and compares the updated operating temperature to a shut-off threshold. The computing system turns off the cooling system responsive to a determination that the updated operating temperature is less than the shut-off threshold. In another embodiment, the computing system detects startup of the electric bicycle, and operates the cooling system for a duration of time after the detected startup.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts an electric bicycle in accordance with an illustrative embodiment.

FIG. 2A is an exploded view of a fan-based cooling system for a bicycle motor in accordance with an illustrative embodiment.

FIG. 2B is a cross-sectional assembled view of the fan-based cooling system for a bicycle motor in accordance with an illustrative embodiment.

FIG. 2C is a close-up cross-sectional view of the bicycle fan system that depicts airflow in accordance with an illustrative embodiment.

FIG. 2D includes front and side views of intake ports in the battery cover 315 in accordance with an illustrative embodiment.

FIG. 2E includes front, back, and mounted views of the fan mount in accordance with an illustrative embodiment.

FIG. 2F includes front, back, and mounted views of the motor cover in accordance with an illustrative embodiment.

FIG. 2G includes front and rear perspective views of a fan for use with the cooling system.

FIG. 2H is a table that depicts specifications of the fan in accordance with an illustrative embodiment.

FIG. 2I depicts perspective and mounted views of the fan controller in accordance with an illustrative embodiment.

FIG. 3 is a graph that shows the motor output over time given constant rider input (180 W) and cadence (75 rpm) in the indoor trainer scenario in accordance with an illustrative embodiment.

FIG. 4 depicts results of a trainer test as a cooled motor efficiency comparison given constant rider input (180 W) and cadence (75 rpm) in the indoor trainer scenario in accordance with an illustrative embodiment.

FIG. 5A depicts a bottom view of a fan-cooled electric motor mounted to a bicycle frame in accordance with an illustrative embodiment.

FIG. 5B depicts a first side view of the fan-cooled electric motor mounted to a bicycle frame in accordance with an illustrative embodiment.

FIG. 5C depicts a second side view of the fan-cooled electric motor mounted to a bicycle frame in accordance with an illustrative embodiment.

FIG. 6 depicts results of field testing the fan-cooled electric motor in accordance with an illustrative embodiment.

FIG. 7 depicts components of an active liquid cooling system in accordance with an illustrative embodiment.

FIG. 8 depicts close-up views of the motor mounted component for a liquid cooled system in accordance with an illustrative embodiment.

FIG. 9 depicts measured surface temperature results of testing the liquid cooled electric bicycle motor in the indoor trainer scenario in accordance with an illustrative embodiment.

FIG. 10 is a block diagram of a computing system to implement the cooling system in accordance with an illustrative embodiment.

### DETAILED DESCRIPTION

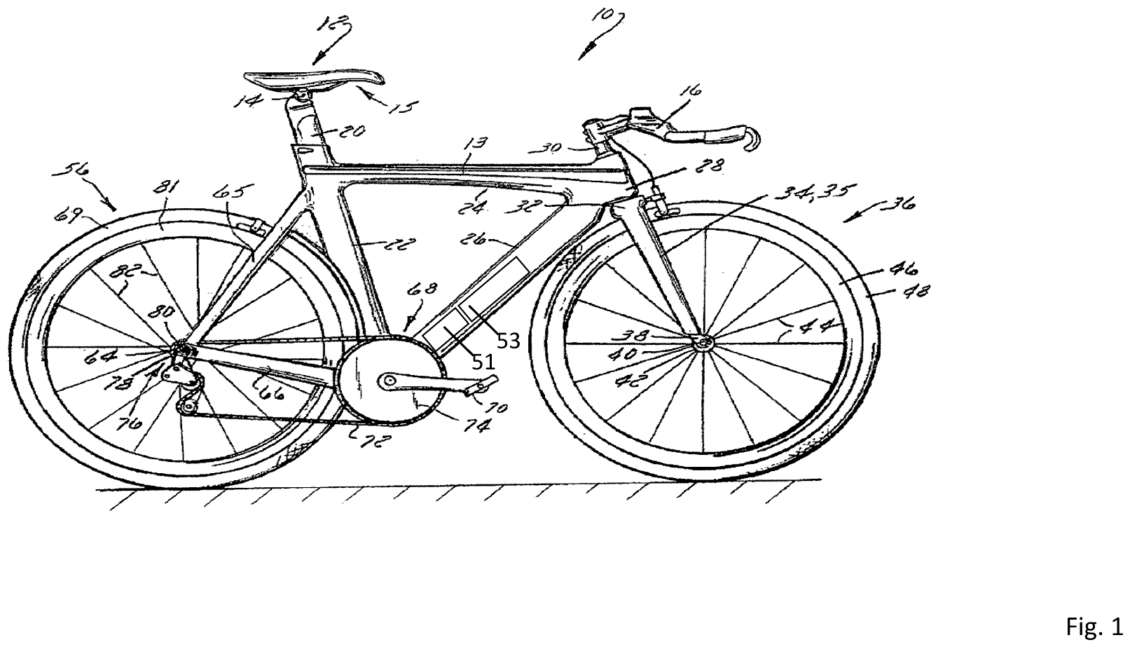

Described herein are cooling systems for an electric bicycle. FIG. 1 depicts an electric bicycle 10 in accordance with an illustrative embodiment. The electric bicycle 10 includes a frame 13 to which a seat assembly 12 and handlebars 16 are attached. A seat clamp 14 is engaged with an underside 15 of seat assembly 12 and cooperates with a dropper post assembly 20 that slidably engages a seat tube 22 of frame 13. The dropper post assembly 20 enables manual or automated low noise adjustment of the seat height. A top tube 24 and a down tube 26 extend forwardly from seat tube 22 to a head tube 28 of frame 13.

Handlebars 16 of the electric bicycle 10 are connected to a steerer tube 30 that passes through head tube 28 and engages a fork crown 32. A pair of fork blades 34, 35 extend from generally opposite ends of fork crown 32 and are constructed to support a front wheel assembly 36 at an end thereof or fork tip 38. The fork blades 34, 35 can be part of a suspension bicycle fork or a rigid bicycle fork. As also shown in FIG. 1, fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42.

A rear wheel assembly 56 is positioned generally concentrically about a rear axle 64. A seat stay 65 and a chain stay 66 offset rear axle 64 from a crankset 68. The crankset 68 includes pedals 70 that are operationally connected to a flexible drive such as a chain 72 via a chain ring or sprocket 74. Rotation of the chain 72 communicates a drive force to a rear section 76 of the bicycle 10 having a gear cluster 78 positioned thereat. The gear cluster 78 is generally concentrically orientated with respect to the rear axle 64 and includes a number of variable diameter gears. The gear cluster 78 is operationally connected to a hub 80 associated with a rear tire 69 of rear wheel assembly 56. A number of spokes 82 extend radially between the hub 80 and a rim 81 that supports tire 69 of rear wheel assembly 56. As is commonly understood, rider operation of the pedals 70 drives the chain 72 thereby driving the rear tire 69 which in turn propels the bicycle 10.

The electric bicycle 10 also includes an electric motor 51 and associated cooling system, and a battery 53 that is used to power the electric motor 51. As shown, both the electric motor 51 and the battery 53 are mounted within the down tube 26 of the electric bicycle 10. In alternative embodiments, the electric motor 51 and/or batter 53 can be mounted in a different tube e.g., tope tube 24 or seat tube 22). Alternatively, the electric motor 51 and/or the battery 53 can be mounted external to the frame of the electric bicycle 10. The cooling system associated with the electric motor 51 is described in more detail below.

Derating occurs when a bicycle (or other) motor overheats and throttles output to maintain a touchable surface temperature below regulation thresholds. In other words, a motor derates to throttle output power to keep the motor cool (specifically to keep touchable surfaces below ˜70° C. and protect internal electronics). It was found that moving wind over the motor drastically decreases external surface temperatures of a motor. However, this is a problem for mountain bike applications where high-power output demands at low speeds is common. The motor is also typically shrouded to protect it from rock strikes, etc., which reduces air flow. It was found that actively cooling the motor allows for a higher sustained level of output.

Thus, one embodiment is directed to the addition of an electric fan to the downtube/motor mount area of electric bicycles to create an active air cooling system. The fan can be thermostat controlled by the electric bicycle's computer, or another controller/computer can be used to regulate the fan. Additionally, the fan can be powered only when needed (e.g., when a temperature threshold is reached, as determined by the bicycle computer). In an illustrative embodiment, the motor guards have fairing ventilation that act as an intake/exhaust of the air cooling system to strategically push air over the motor and reduce debris. The fan itself can be any fan unit which is able to be exposed to the elements.

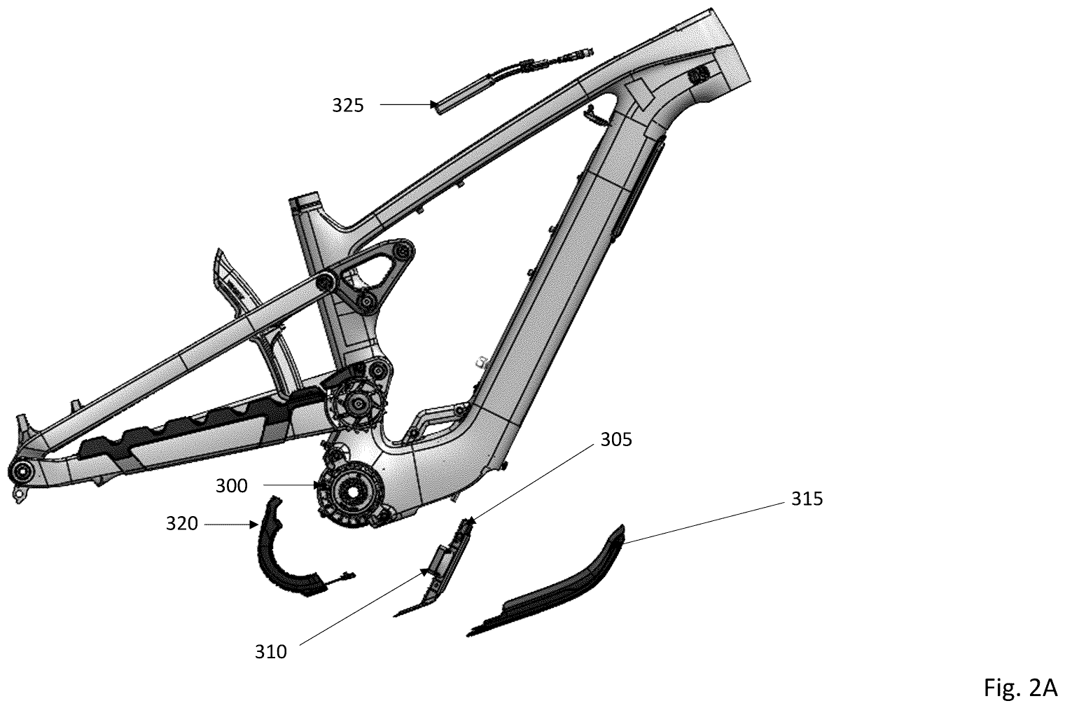

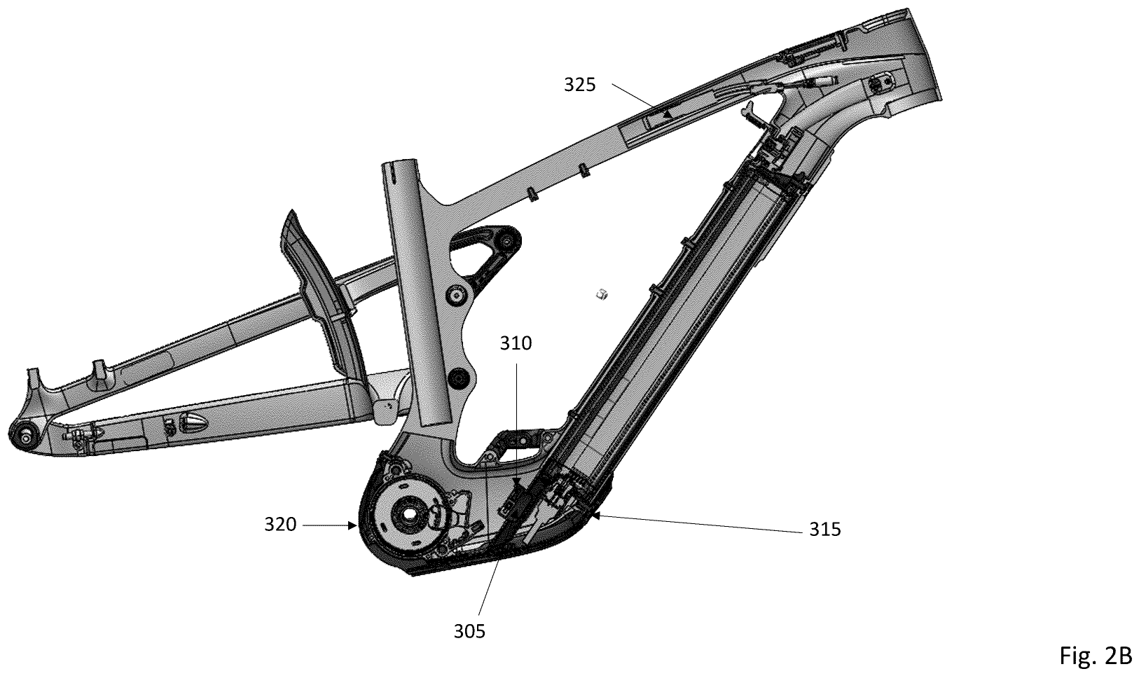

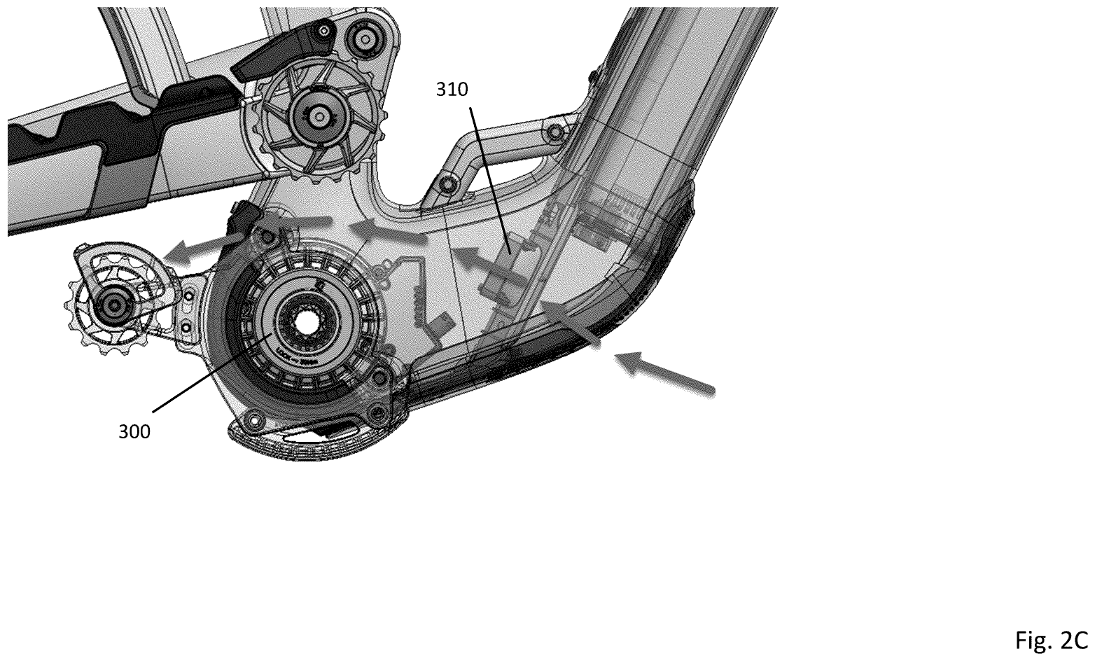

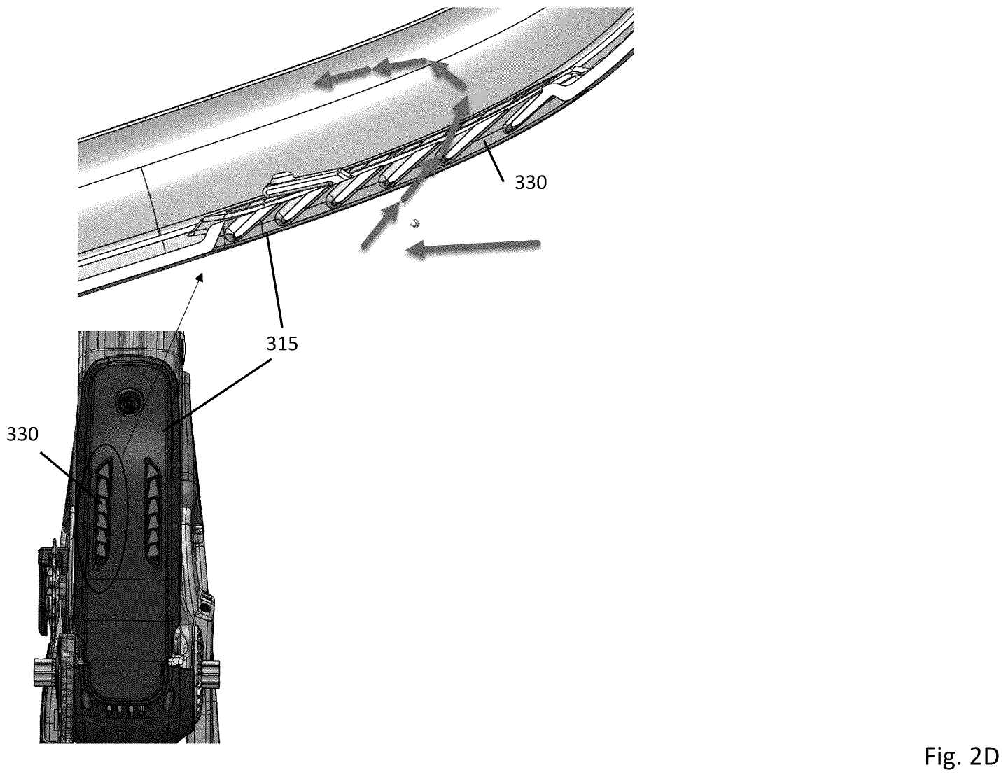

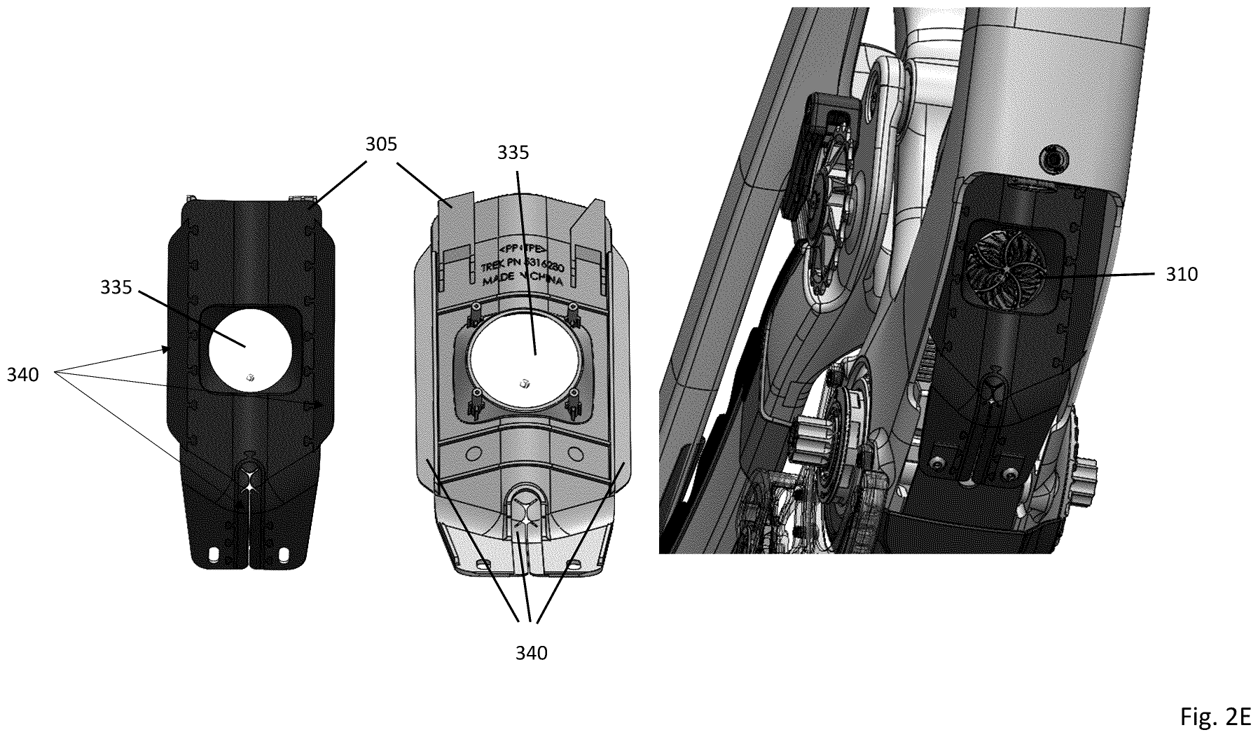

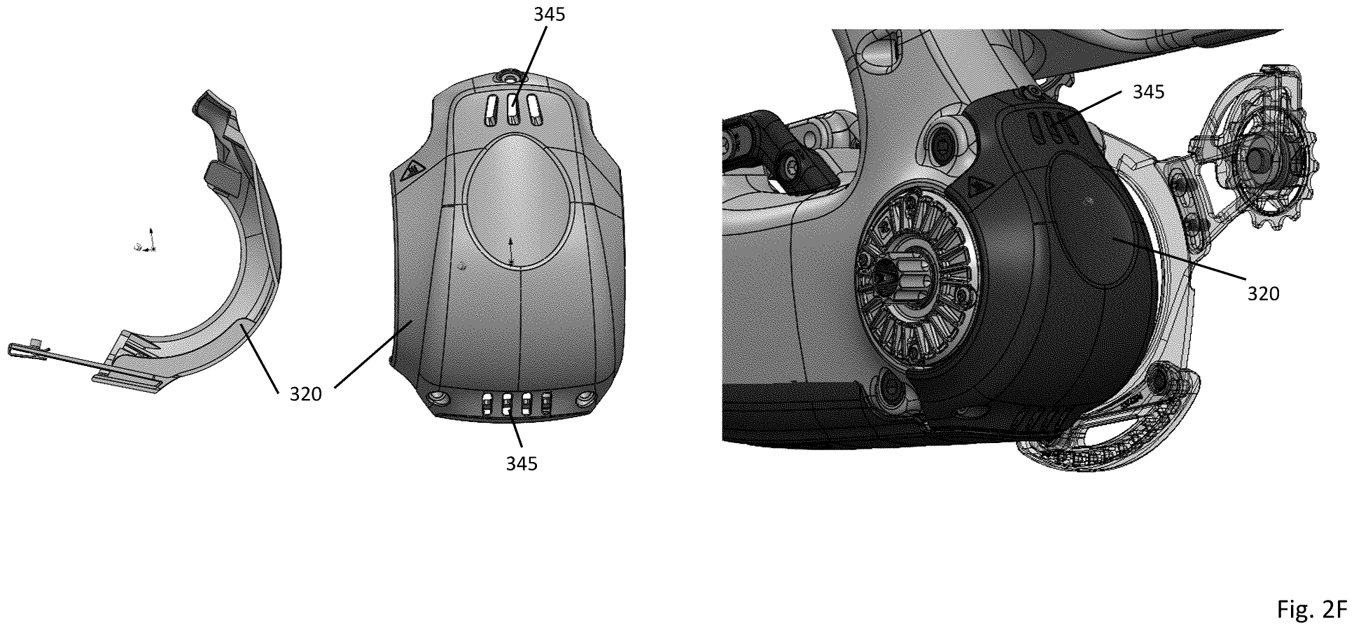

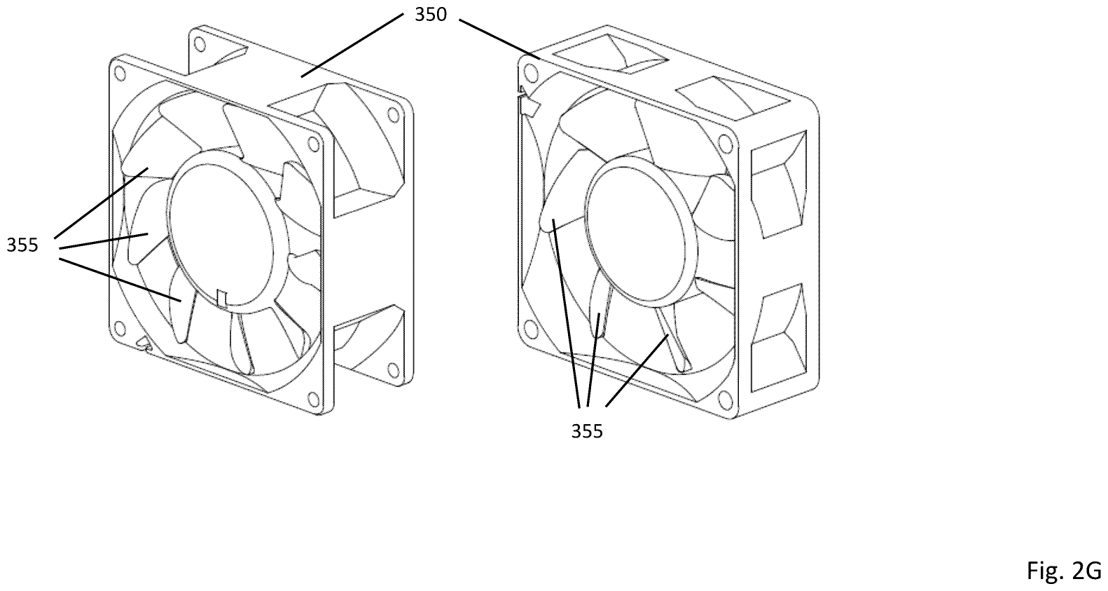

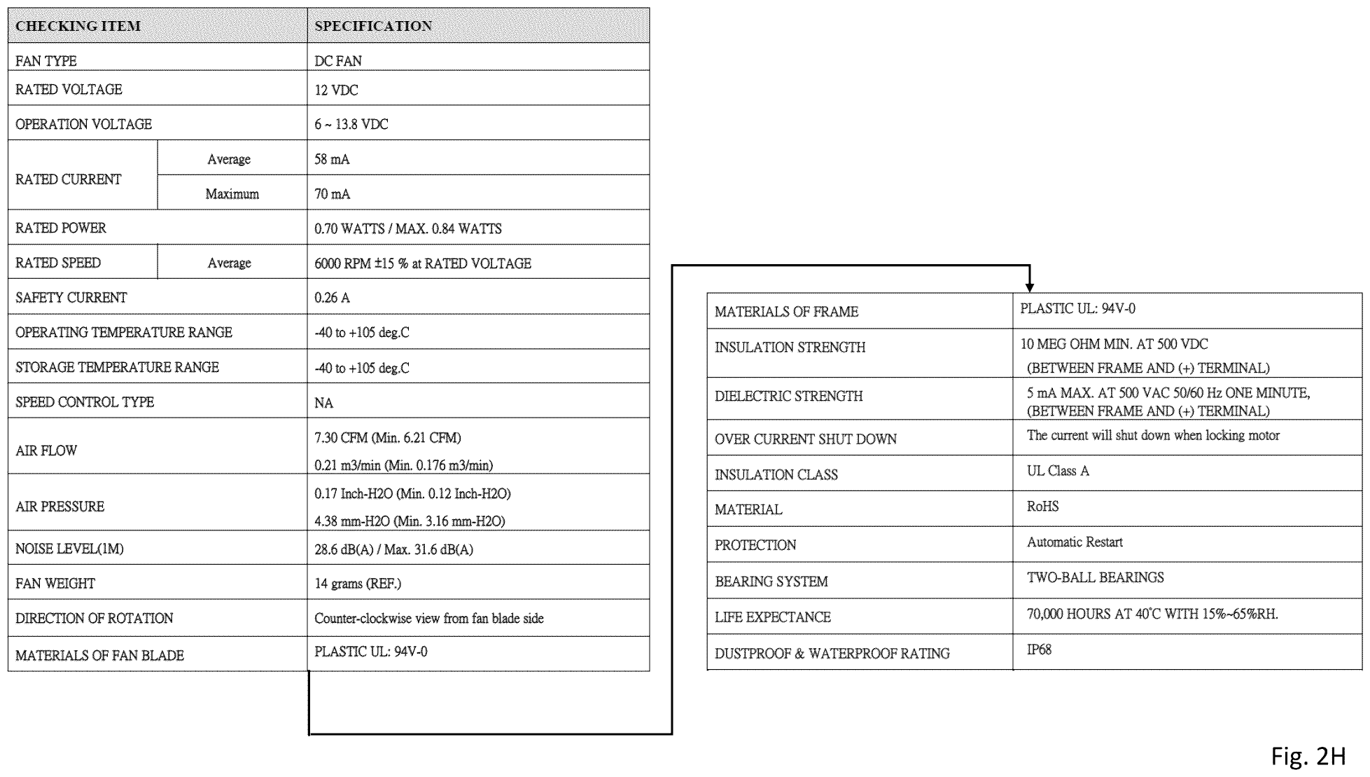

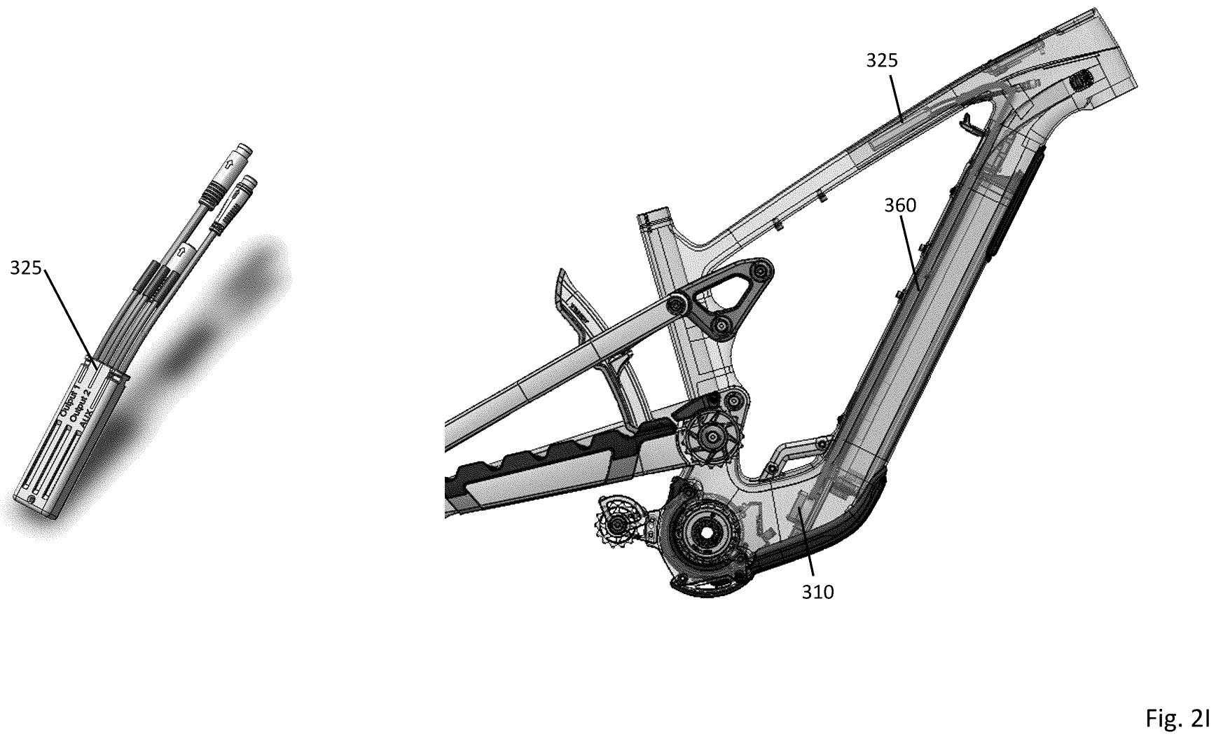

FIG. 2A is an exploded view of a fan-based cooling system for a bicycle motor in accordance with an illustrative embodiment. FIG. 2B is a cross-sectional assembled view of the fan-based cooling system for a bicycle motor in accordance with an illustrative embodiment. As shown, the bicycle includes a motor 300 mounted to the bicycle frame. A fan mount 305 has a fan 310 mounted thereto. The fan mount 305 attaches to the downtube of the bicycle frame. In an alternative embodiment, the fan 310 and/or fan-cooled motor 300 may be mounted in a different tube such as the seat tube of the bicycle frame. A battery cover 315 covers a battery that is mounted within the down tube. When mounted, the battery cover 315 covers at least a portion of the fan mount 305 and the fan 310 in one embodiment. A motor cover 320 is used to cover the motor 300 and protect it from flying debris. A fan controller (e.g., computing system) 325 is used to control operation of the fan 310.

FIG. 2C is a close-up cross-sectional view of the bicycle fan system that depicts airflow in accordance with an illustrative embodiment. As shown, the airflow path of the fan 310 is designed to push air over the top of the motor 300, where it is hottest and unexposed to naturally moving air during bicycle operation. As shown, intakes were designed into the battery cover to improve natural airflow in addition to the new forced airflow. Exhaust holes were also formed in the motor cover to further facilitate airflow. The intakes and exhaust openings are described in more detail below. In alternative embodiments, the intakes and exhaust openings can be formed in the bicycle frame.

FIG. 2D includes front and side views of intake ports 330 in the battery cover 315 in accordance with an illustrative embodiment. The battery cover 315 is designed to allow the battery to be removed out of the bottom of the frame, while protecting the downtube and the motor. In an illustrative embodiment, the air intake ports 330 are ribbed and overlap one another (as shown) to prevent the collection of dust/debris inside the motor cavity. As noted, in an alternative embodiment, the air intake ports can be formed directly in the frame of the bicycle.

FIG. 2E includes front, back, and mounted views of the fan mount 305 in accordance with an illustrative embodiment. As shown, the fan mount 305 includes an opening 335 that receives the fan 310 and that allows for airflow through the fan mount 305. A complete thru-hole in the fan mount for the fan was found to be the quietest option for air intake. The fan mount 305 also includes gasket edges 340 to force airflow as intended over the motor and to prevent gaps in the assembly. The gasket edges 340 are rubber edges attached to the hard plastic fan mount 305 and used to create a seal with the walls of the downtube (or other tube to which the fan is mounted). This seal prevents leaks and ensures that the airflow is directed over the electric motor by the fan. In an illustrative embodiment, the fan is mounted to the back of the fan mount 305 using 4 self-tapping screws. Alternatively, a different mounting method may be used, such as bolts, adhesive, co-molding, etc.

FIG. 2F includes front, back, and mounted views of the motor cover 320 in accordance with an illustrative embodiment. The motor cover 320 is designed to protect the motor from rock strikes and debris that can result from rotation of the rear tire. Ventilation (or exhaust) ports 345 are included in the motor cover 320 to increase both active and passive cooling via increased air flow. As shown, the motor cover 320 includes a first set of three exhaust ports 345 formed at a top of the motor cover and a second set of four exhaust ports 345 formed at a bottom of the motor cover. In alternative embodiments, fewer or additional numbers of sets of exhaust ports may be used, each set may have a different number of exhaust ports, and/or the set(s) may be located at different positions on the motor cover 320. In another alternative embodiment, the one or more sets of exhaust ports can be formed on the bicycle frame.

FIG. 2G includes front and rear perspective views of a fan for use with the cooling system. As shown, the fan 310 includes a vented housing 350 to which is mounted a rotating set of fan blades 355. The fan 310 was selected with size, noise, power, cost, and dust/waterproof rating constraints that are suitable for a cycling application. In an illustrative embodiment, the fan 310 can sense an interference (or blockage) and turn itself off. The fan is then designed to operate in a pulse mode until the blockage is removed and the fan is able to continue normal operation. This means the fan is safe for fingers/sticks/etc. and will not easily break. FIG. 2H is a table that depicts specifications of the fan 310 in accordance with an illustrative embodiment. In an alternative embodiment, a different type of fan having different specifications may be used.

FIG. 2I depicts perspective and mounted views of the fan controller (e.g., computing system) 325 in accordance with an illustrative embodiment. As shown, the fan controller 325 is mounted in a cavity in the top tube of the bicycle frame. A control line 360 is connected to the fan controller 325 and to the fan 310. The control line 360 runs from the top tube, through the down tube, and to the fan 310, and is used to control operation of the fan 310. In an alternative embodiment, the fan controller 325 and/or the control line 360 can be located at a different position on or in the bicycle frame. In an illustrative embodiment, the fan controller 325 uses power from the bicycle battery to power both itself and the fan 310. In another illustrative embodiment, a temperature sensor is connected to the control line 360 and used to monitor a temperature of the motor. Upon reaching a threshold temperature that is detected by the temperature sensor, the fan controller 325 causes the fan 310 to turn on and begin cooling the motor.

In an illustrative embodiment, in operation, the fan controller 325 causes the fan 310 to operate for an interval of time (e.g., 1 second, 3 seconds, 10 seconds, 30 seconds, 60 seconds, etc.) upon startup (i.e., pedaling and/or use of the motor) of the bicycle to ensure that the fan 310 is spun at regular intervals. As discussed above, the fan 310 also turns on when a specified internal motor temperature is reached, as sensed by the temperature sensor. This prevents the motor from overheating and exceeding regulation touchable surface temperatures. In one embodiment, the threshold temperature is the temperature at which the motor would start to throttle power in a derating mode. The fan continues to run until a specified lower internal motor temperature threshold is reached, as detected by the temperature sensor. The use of this lower threshold prevents the fan from rapidly turning on/off if the temperature is hovering at the engagement temperature, and means the airflow only stops when the motor is truly cooled.

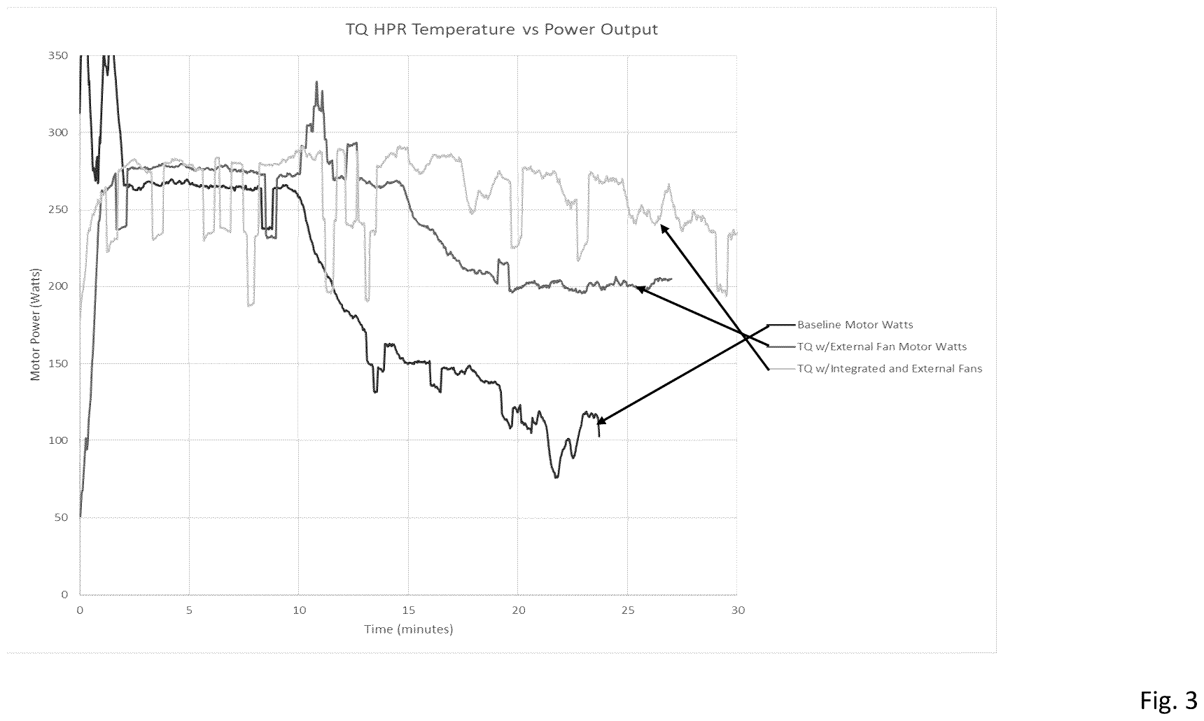

The inventors have completed both indoor trainer testing as well as field testing with a bicycle equipped with a fan-cooled electric motor. FIG. 3 is a graph that shows the motor output over time given constant rider input (180 Watts (W)) and cadence (75 rotations per minute (rpm)) in the indoor trainer scenario in accordance with an illustrative embodiment. The baseline is a worst case scenario and shows motor support drops from 250 W to 130 W over the course of 20 minutes. The external fan simulates air moving over the whole frame (as if the bike was moving in a real world scenario with passive cooling) which still leads to a decrease in support to 200 W. Adding the integrated fan maintains motor support of 250 W over the same period of time.

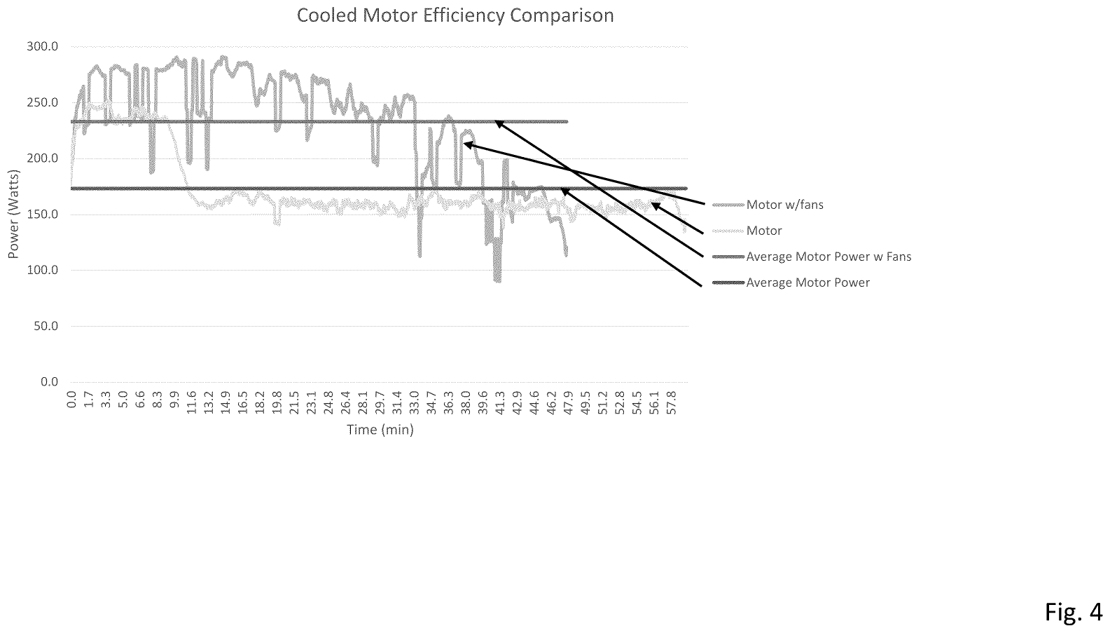

In another trainer test, riders maintained a sustained input of approximately 175 W and drained a battery from 100% to 10%. With a worst case scenario of still air, the motor provided an average of 173 W of support. With a cooled motor scenario (integrated and external fans), the output average was 232 W. This demonstrates the potential increase in motor output when the system temperatures are moderated. FIG. 4 depicts results of the trainer test as a cooled motor efficiency comparison given constant rider input (180 W) and cadence (75 rpm) in the indoor trainer scenario in accordance with an illustrative embodiment.

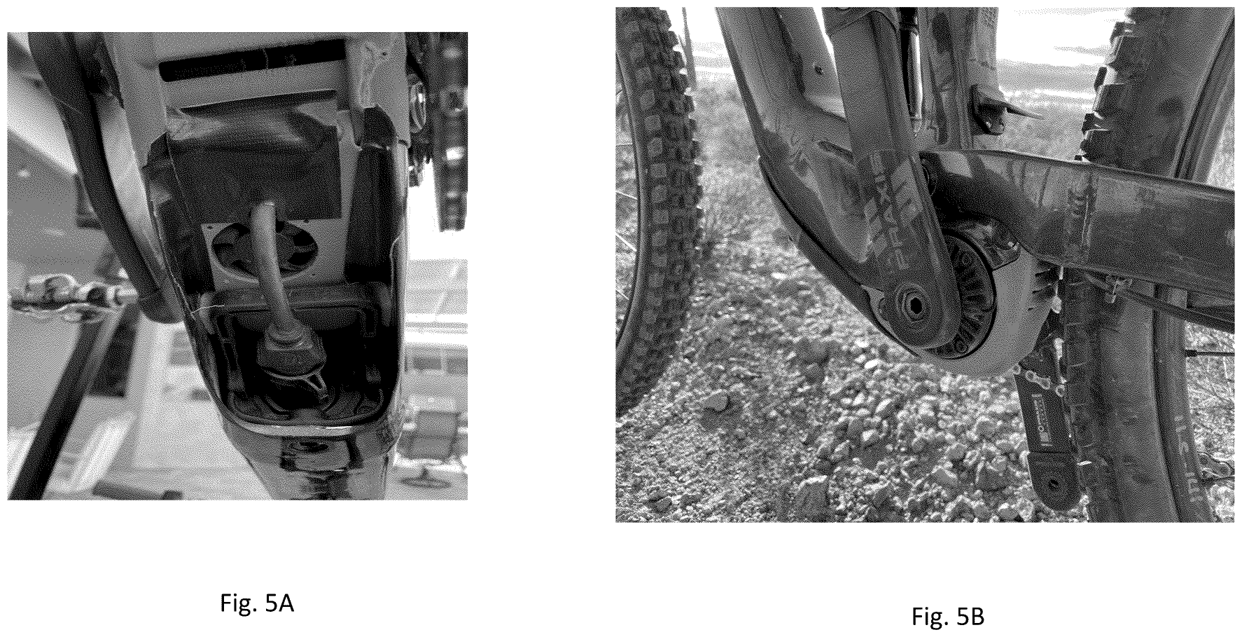

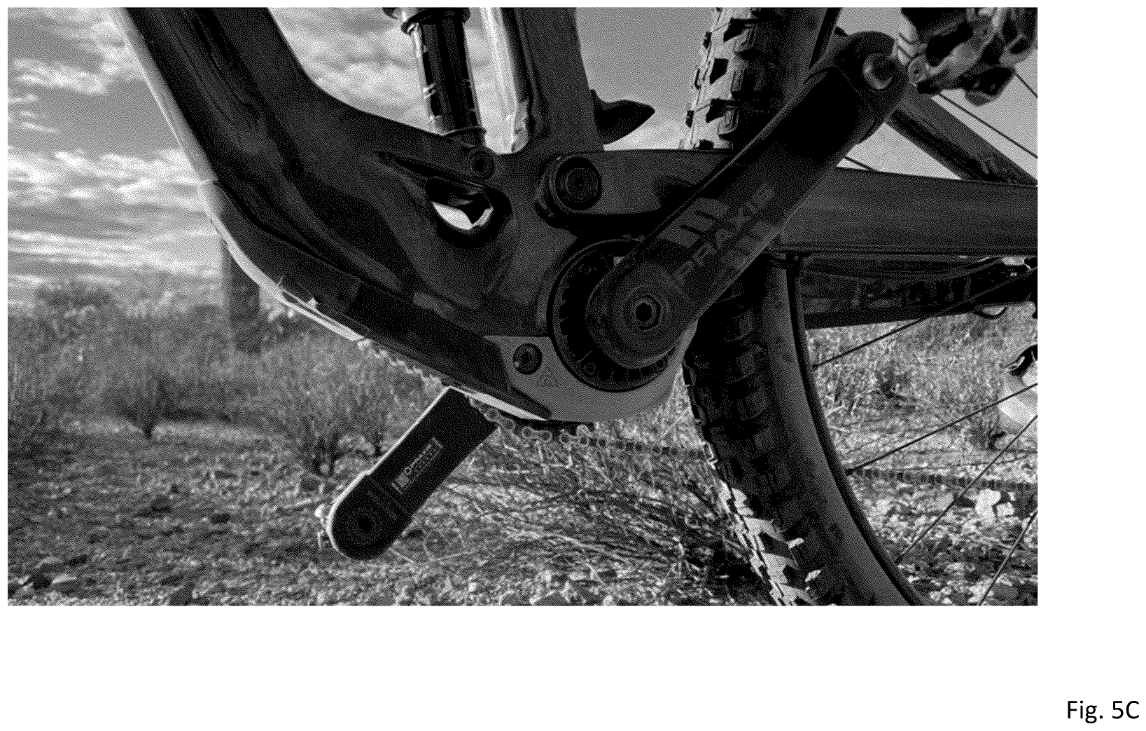

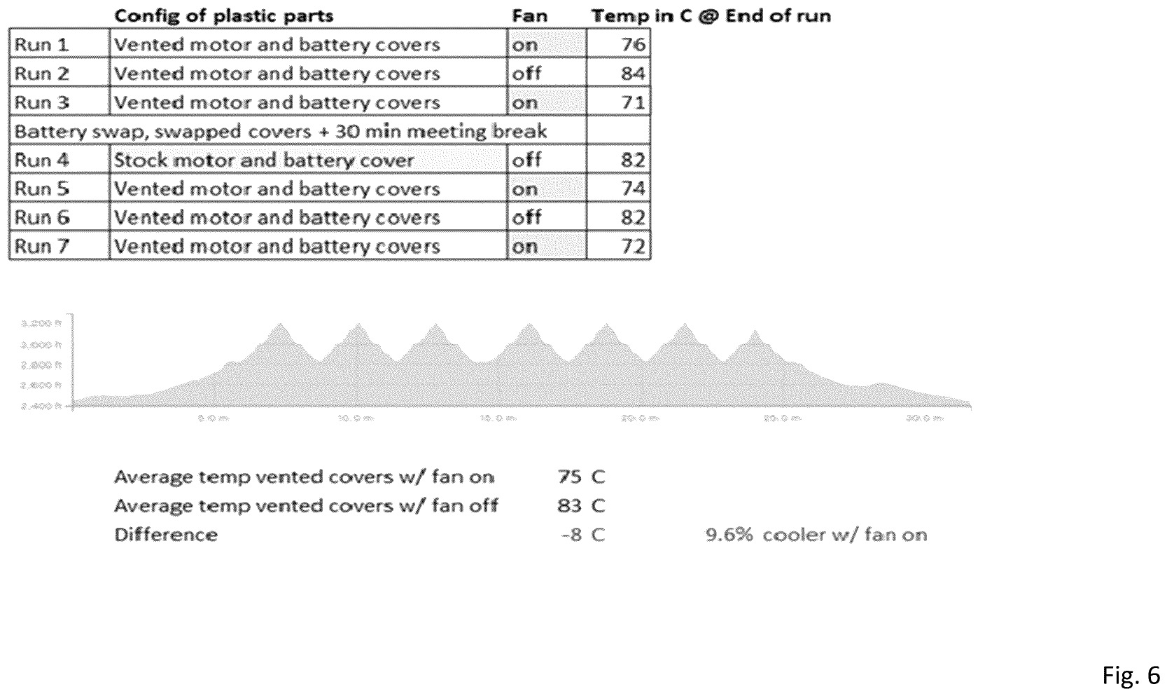

Field testing of the proposed fan-cooled electric motor was also completed. A rider repeated 1.3 mi hill climbs with a consistent starting motor temperature (60° C.) and recorded temperatures after the climb with the fan (75° C. average) and without the fan running (83° C. average). This correlates to a 10% cooler motor with the fan running. Riding the bike with ventilated covers alone (no forced air) did not result in decreased motor temperatures. This testing was completed during a mild 71-73° F. day using the electric bicycle depicted in FIG. 5. Specifically, FIG. 5A depicts a bottom view of a fan-cooled electric motor mounted to a bicycle frame in accordance with an illustrative embodiment. FIG. 5B depicts a first side view of the fan-cooled electric motor mounted to a bicycle frame in accordance with an illustrative embodiment. FIG. 5C depicts a second side view of the fan-cooled electric motor mounted to a bicycle frame in accordance with an illustrative embodiment. FIG. 6 depicts results of field testing the fan-cooled electric motor in accordance with an illustrative embodiment.

In an illustrative embodiment, the active air cooling system for an electric bicycle motor is designed to be extremely lightweight and durable. It can also be integrated into the bicycle computer system and dependent on unique bicycle parameters. In another illustrative embodiment, the proposed system can be a standalone system that is able to integrate into the computing/control system of any existing electronic bicycle. The fan and its supporting hardware are also designed to provide the quietest, least noticeable experience. An additional advantage of this active air cooling system is its separation from the motor such that the fan and motor can be replaced independent of one another.

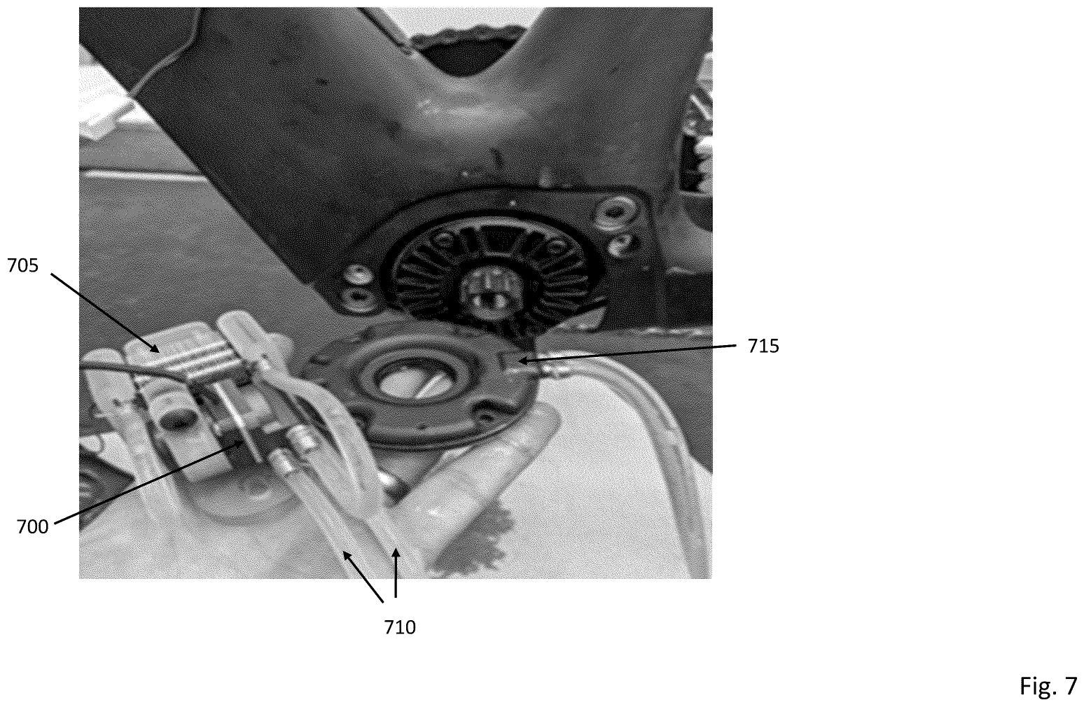

Another embodiment relates to an active liquid cooling system for motors in electric bicycle applications. Similar to the fan system, an active liquid cooling system can be used on any electric bicycle to improve performance of the motor system. FIG. 7 depicts components of an active liquid cooling system in accordance with an illustrative embodiment. As shown, the system includes a pump 700, a heat exchanger and fan 705, coolant in tubing 710, and a motor mounted component 715 for integration. The pump 700 moves the coolant 710 through the system to cool the motor mounted component (i.e. motor cover) 715 and draw heat away from the motor. The coolant carries away heat as it cycles through the tubes and the heat exchanger 705 dissipates the heat to the environment via its fan. The motor has internal temperature thermocouples (temperature sensors) mounted thereto that control when the system is engaged for cooling. For example, the system can be moderated by a computer or other controller to turn on when a temperature threshold is reached, and also to turn off when a cooled temperature threshold is achieved.

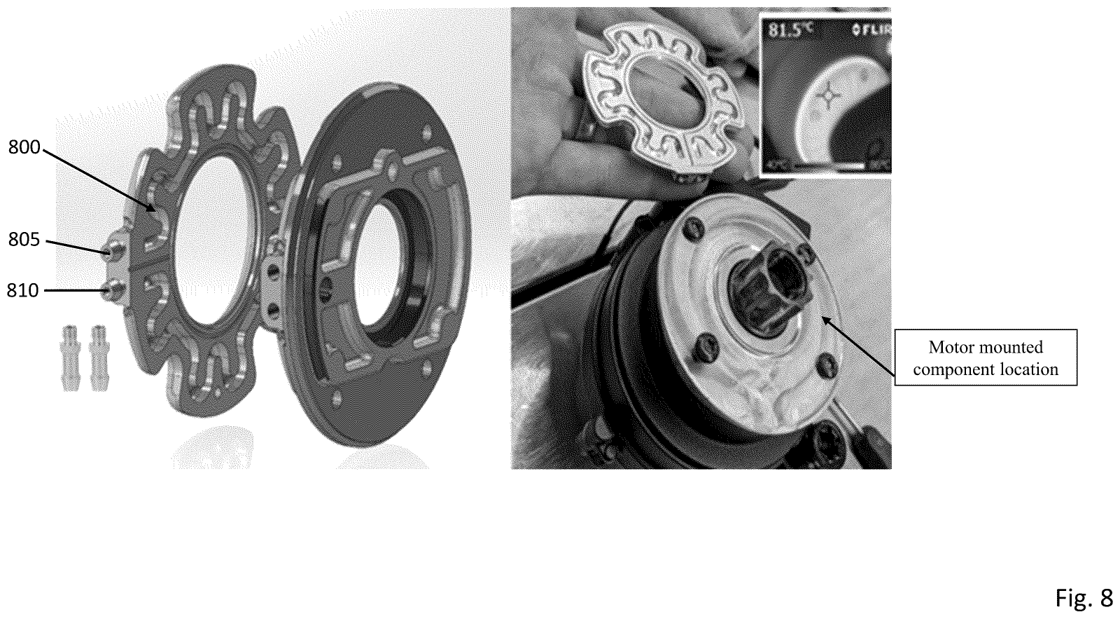

FIG. 8 depicts close-up views of the motor mounted component (motor cover) 715 for a liquid cooled system in accordance with an illustrative embodiment. As shown, the motor mounted component is in the form of a plate, one side of which includes an internal coolant path 800 etched into the cover. The internal coolant path 800 has an inlet valve 805 and an outlet valve 810 that allow the pump to circulate coolant through the motor mounted component. The motor mounted component 715 mounts directly to the motor such that the coolant is able to receive heat from the motor and draw the heat away from the motor using the coolant in tubing 710 such that the heat is dissipated by the heat exchanger/fan 705.

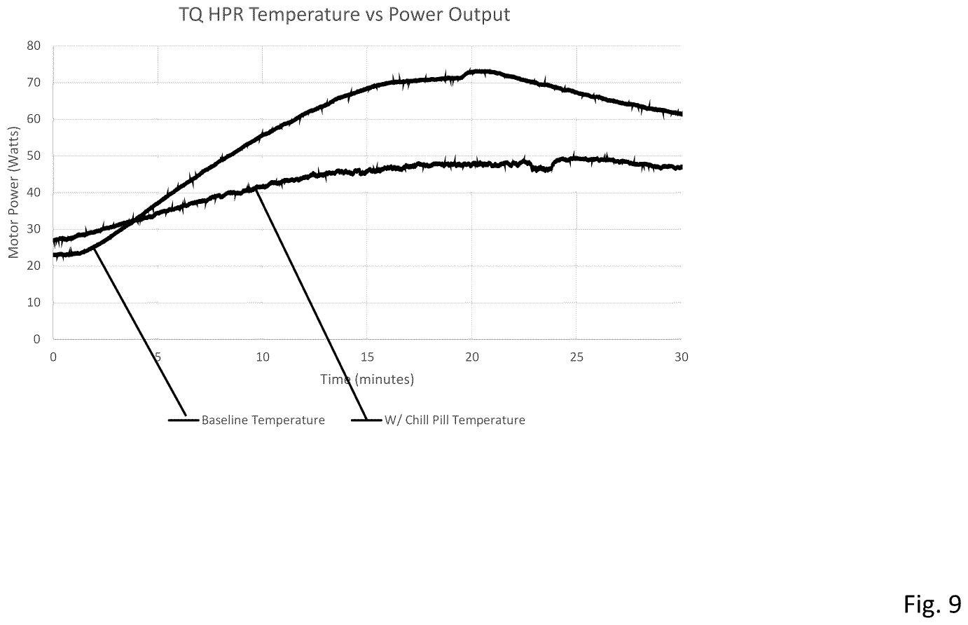

Similar to the air/fan-cooled embodiment described above, an active liquid cooling system reduces derating of the electric motor, which results in a cooled motor that operates more efficiently than traditional bicycle motors. The active liquid cooling system has been prototyped and tested in an indoor trainer setup. The system was installed on a bicycle equipped with a TQ HPR50 motor. Alternatively, a different type/brand of motor may be used. The rider provided 180 W of input power to get the maximum motor output (250 W) for 30 minutes to reach the derating surface temperature. The surface temperature was tracked with the baseline motor and with the active liquid cooling system. With the liquid cooled system, the surface temperature was 31.5% lower. A lower surface temperature would enable the motor to reach higher internal operating temperatures before throttling support and maintain compliance with safety standards. FIG. 9 depicts measured surface temperature results of testing the liquid cooled electric bicycle motor in the indoor trainer scenario in accordance with an illustrative embodiment.

This initial prototype targeted cooling the touchable external surface, but the motor mounted component could also be reconfigured to draw heat away from the main stator of the motor. Mounting the cooling plate to the main stator would keep the overall motor temperature lower and thus the touchable surface. In one embodiment, the mounting plate could also be integrated into the motor housing rather than being a separate piece.

Thus, the proposed integrated active cooling system can be used on any electric bicycle to improve performance of the motor system. The integrated active cooling system reduces derating. A cooled motor also operates more efficiently, thus increasing the output of the motor over the duration of the battery life. This is particularly important in scenarios such as mountain biking where the motor experiences high torque inputs, but slow speeds that result in limited air moving over the motor for passive cooling. While specific components of the system are described herein, it is to be understood that the system is not limited to the components described herein, and that different types of motors, sensors, controllers, processors, etc. can alternatively be used to implement the system.

In some embodiments, the active cooling systems described herein can be controlled by a computing system, such as a bicycle computer. The computing system can include a processor, a memory, a user interface, a transceiver (e.g., a receiver and a transmitter), etc. The computing system can perform any of the operations described herein, such as monitoring a temperature of an electric motor, comparing a sensed temperature to a threshold, activating a cooling system responsive to the threshold being met, etc. For example, the operations described herein can be implemented as computer-readable instructions that are stored in the memory. Upon execution of the computer-readable instructions by the processor, the computing system performs the operations described herein.

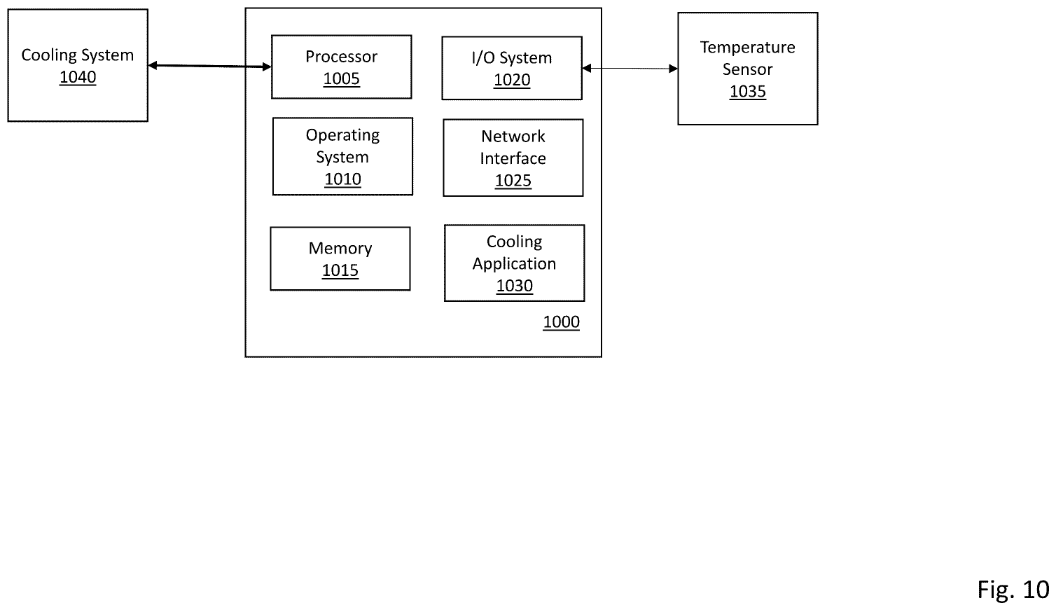

As an example, FIG. 10 is a block diagram of a computing system to implement the cooling system in accordance with an illustrative embodiment. The computing system 1000 is in communication with a temperature sensor 1035. The temperature sensor 1035 is mounted on or proximate to the bicycle motor to detect the temperature thereof, and can be any type of thermocouple of temperature sensor known in the art. The temperature sensor 1035 can communicate directly with the computing system 1000 through a wired connection in one embodiment. Alternatively, the temperature sensor 1035 may communicated wirelessly (device-to-device or through a network) with the computing system 1000.

The computing system 1000 includes a processor 1005, an operating system 1010, a memory 1015, an input/output (I/O) system 1020, a network interface 1025, and a cooling application 1030. In alternative embodiments, the computing system 1000 may include fewer, additional, and/or different components. The components of the computing system 1000 communicate with one another via one or more buses or any other interconnect system. The computing system 1000 can be any type of computing device that has sufficient processing power to perform the operations described herein.

The processor 1005 can be in electrical communication with and used to control any of the system components described herein. For example, the processor can be used to execute the cooling application 1030, process received user selections, send data and commands to a cooling system 1040, receive raw data from the temperature sensor 1035, process the data using the algorithms described herein, etc. The processor 1005 can be any type of computer processor known in the art, and can include a plurality of processors and/or a plurality of processing cores. The processor 1005 can include a controller, a microcontroller, an audio processor, a hardware accelerator, a digital signal processor, etc. Additionally, the processor 1005 may be implemented as a complex instruction set computer processor, a reduced instruction set computer processor, an x86 instruction set computer processor, etc. The processor 1005 is used to run the operating system 1010, which can be any type of operating system.

The operating system 1010 is stored in the memory 1015, which is also used to store programs, user data, pacemaker readings, network and communications data, peripheral component data, the cooling application 1030, and other operating instructions. The memory 1015 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The I/O system 1020 is the framework which enables users and peripheral devices to interact with the computing system 1000. The I/O system 4100 can include a display, one or more speakers, one or more microphones, a keyboard, a mouse, one or more buttons or other controls, etc. that allow the user to interact with and control the computing system 1000. The I/O system 1020 also includes circuitry and a bus structure to interface with peripheral computing devices such as power sources, universal service bus (USB) devices, data acquisition cards, peripheral component interconnect express (PCIe) devices, serial advanced technology attachment (SATA) devices, high definition multimedia interface (HDMI) devices, proprietary connection devices, the temperature sensor 1035, etc.

The network interface 1025 includes transceiver circuitry (e.g., a transmitter and a receiver) that allows the computing system 1000 to transmit and receive data to/from other devices, other remote computing systems, servers, websites, etc. The network interface 1025 enables communication through a computer network, which can be one or more communication networks. The network can include a cable network, a fiber network, a cellular network, a wi-fi network, a landline telephone network, a microwave network, a satellite network, etc. The network interface 1025 also includes circuitry to allow device-to-device communication such as Bluetooth® communication.

The cooling application 1030 can include software and algorithms in the form of computer-readable instructions which, upon execution by the processor 1005, performs any of the various operations described herein such as receiving temperature data, comparing temperature data to a threshold temperature, controlling operation of the cooling system 1040 (air fan or coolant system) based on the comparison, detecting startup of the bicycle and operating the cooling system 1040 for a duration after startup, transmitting data, receiving data, shutting the cooling system down in response to a detected blockage, operating the cooling system in pulse mode until a blockage is removed, etc. The cooling application 1030 can utilize the processor 1005 and/or the memory 1015 as discussed above. In an alternative implementation, the cooling application 1030 can be remote or independent from the computing system 1000, but in communication therewith.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An electric bicycle comprising:
a frame that includes a top tube, a down tube, and a seat tube;
an electric motor mounted on or within at least one of the down tube and the seat tube; and
a cooling system mounted proximate to the electric motor, wherein the cooling system maintains a desired operating temperature for the electric motor.

2. The electric bicycle of claim 1, wherein the cooling system includes a fan that is configured to blow air over at least a portion of the electric motor to maintain the desired operating temperature.

3. The electric bicycle of claim 2, further comprising a battery cover that covers a battery of the electric bicycle, wherein the battery cover includes a plurality of air intake vents that act as an intake for the fan.

4. The electric bicycle of claim 2, further comprising a motor cover that covers the electric motor, wherein the motor cover includes a first plurality of exhaust vents that act as an exhaust for the fan.

5. The electric bicycle of claim 4, wherein the first plurality of exhaust vents are positioned at a top of the motor cover, and further comprising a second plurality of exhaust vents positioned at a bottom of the motor cover.

6. The electric bicycle of claim 2, further comprising one or more exhaust vents that act as an exhaust for the fan and one or more air intake vents that act as an intake for the fan, wherein at least one of the one or more exhaust vents and the one or more air intake vents are formed in the frame of the bicycle.

7. The electric bicycle of claim 2, further comprising a fan mount that mounts to the frame, wherein the fan mount includes an opening to receive the fan.

8. The electric bicycle of claim 7, wherein at least a portion of a perimeter of the fan mount includes gasket edges that form a seal with the frame, wherein the seal prevents air leaks such that airflow from the fan is forced over the electric motor.

9. The electric bicycle of claim 2, wherein the fan enters a pulse mode in response to detection of a fan blockage, and wherein the fan intermittently pulses during the pulse mode until the fan blockage is no longer present.

10. The electric bicycle of claim 1, wherein the cooling system includes a pump that distributes a coolant over at least a portion of the electric motor to maintain the desired operating temperature.

11. The electric bicycle of claim 10, wherein the cooling system includes a motor cover that mounts to the electric motor and delivers the coolant to the electric motor.

12. The electric bicycle of claim 11, wherein an interior side of the motor cover that faces the electric motor includes a coolant path that circulates the coolant over the electric motor.

13. The electric bicycle of claim 12, wherein the coolant path is etched into the interior side of the motor cover.

14. The electric bicycle of claim 11, wherein the motor cover includes a coolant input and a coolant output that enables circulation of the coolant along the motor cover, wherein the coolant input and the coolant output are each connected to a coolant tube that connects to the pump.

15. The electric bicycle of claim 1, further comprising a temperature sensor mounted on or proximate to the electric motor, wherein the temperature sensor detects an operating temperature of the electric motor.

16. The electric bicycle of claim 15, further comprising a computing system to receive the operating temperature of the electric motor from the temperature sensor.

17. The electric bicycle of claim 16, wherein the computing system is mounted in the top tube of the frame.

18. The electric bicycle of claim 16, wherein the computing system compares the operating temperature of the electric motor to a threshold temperature, and wherein the computing system activates the cooling system responsive to a determination that the operating temperature exceeds the threshold temperature.

19. The electric bicycle of claim 18, wherein the computing system receives an updated operating temperature of the electric motor and compares the updated operating temperature to a shut-off threshold, and wherein the computing system turns off the cooling system responsive to a determination that the updated operating temperature is less than the shut-off threshold.

20. The electric bicycle of claim 1, further comprising a computing system operably coupled to the cooling system, wherein the computing system detects startup of the electric bicycle, and wherein the computing system operates the cooling system for a duration of time after the detected startup.
